(19) United States
(12) Patent Application Publication
(10) Pub. No.: US 2009/0076238 A1
(43) Pub. Date: Mar. 19, 2009

(54) Mono-or Poly-Quarternary Polysiloxanes

(76) Inventors: Horst Lange, Bochum (DE); Roland Wagner, Bonn (DE); Anita Witossek, Langenfeld (DE); Karl-Heinz Stachulla, Leverkusen (DE); Siegfried Teuber, Krefeld (DE); Martin Kropfgans, Odenthal (DE); Karl-Heinz Sockel, Leverkusen (DE); Don Firstenberg, Erkrath (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/333,730

(22) PCT Filed: Jul. 27, 2001
(86) PCT No.: PCT/EP01/08698

§ 371 Date: Oct. 24, 2008

(30) Foreign Application Priority Data
Jul. 27, 2000 (DE) 100 36 524.8

(51) Int. Cl. C08G 77/14; C08G 77/06

(52) U.S. Cl. 528/28

(57) ABSTRACT

Monoquaternary or polyquaternary polysiloxanes are useful as surface finishing components, for example, in cosmetic formulas for skin and hair care, in polishes for the treatment of hard surfaces, in formulas for the drying of automobiles and other hard surfaces after machine washing, for the treatment of textiles and textile fibers, as separate softeners for textiles following the washing whereof with nonionic or anionic/non-ionic detergent formulas, or as softeners in formulas for textile washing based on non-ionic or anionic/non-ionic surfactants, whereby amino groups are used in the form of amines or amine salts as a function of pH value.

The invention concerns monoquaternary or polyquaternary polysiloxanes, their manufacture and use as surface finishing components.

EP-A-0 441 530 describes a textile softener made of polysiloxane, which contains tertiary amine groups in silk chains. Also described is the reaction of α,ω-epoxy-modified siloxanes with piperazine, which depends upon the piperazine mixture used, to produce oligomeric or polymeric structures with tertiary amine functions in the main chains, such as described in U.S. Pat. No. 4,847,154.

The further introduction of ethylene oxide/propylene oxides as hydrophilic components leads to an improvement of the effect. To this end it is proposed on the one hand, to position alkylene oxides and tertiary amine groups in silk chains, which are bonded to ester structures by the main siloxane chain, as described in U.S. Pat. No. 5,591,880 and U.S. Pat. No. 5,650,529. The drawback here is the complicated esterification in the presence of amino groups. The alternative to this is known, to bring about a reaction between α,ω-epoxy-modified siloxanes and polyalkylene oxides having secondary amine functions, as described in U.S. Pat. No. 5,981,681.

Branched alkaline oxide-modified quaternary polysiloxanes are synthesized from α,ω-OH terminated polysiloxanes and trialkoxysilanes by means of condensation. U.S. Pat. No. 5,602,224 describes quaternary ammonium structures, to which silanes are introduced, where the quaternary nitrogen atom is replaced by alkylene oxide units.

Strictly comb-like alkylene oxide-modified polysiloxane quaternary compounds are similarly described in U.S. Pat. No. 5,098,979. The hydroxyl groups of the comb-structured substituted polyethersiloxanes were transformed with epichlorohydrin into the corresponding chlorohydrin derivative. This is followed by a quaternation with tertiary amines. A drawback of this strategy is that it requires dealing with epichlorohydrin, and the relatively slight reactivity of the chlorohydrin group during quaternation.

For this reason, the hydroxyl groups of comb-structured substituted polyethersiloxanes are instead esterized with chloroacetic acid. Through the carbonyl activation the final quaternation can be more easily achieved, as described in U.S. Pat. No. 5,153,294 and U.S. Pat. No. 5,166,297.

WO 01/41719 and WO 01/41720, published after the priority day of this announcement, describe quaternary polysiloxane compounds for use in cosmetic preparations.

α,ω-biquaternary polysiloxanes are described in U.S. Pat. No. 4,891,166. Synthesis occurs by a reaction of α,ω-diepoxides with tertiary amine groups in the presence of acids.

U.S. Pat. No. 4,833,225 describes linear polyquaternary polysiloxanes, which are produced by a reaction of α,ω-diepoxides with ditertiary amines in the presence of acids. Alternatively, it is possible to transform α,ω-halogen alkyl modified siloxanes with ditertiary amines into polymer polyquaternary compounds, such as described in U.S. Pat. No. 4,587,321.

The substances according to U.S. Pat. No. 4,891,166, U.S. Pat. No. 4,833,225 and U.S. Pat. No. 4,587,321 have a marked tendency to shrink on solid body surfaces. With the compounds described here, it is a question of the nature of either α,ω-bisfunctional polysiloxanes, corresponding chain-like (AB)η copolymers, comb-like functionalized siloxane or rather products with a portion in branching positions of siloxane chains.

In DE-OS 43 18 536, DE-OS 44 37 886 and the publications of R. Wagner, L. Richter, B. Weiland, J. Reiners, J. Weissmüller, Appl. Organomet. Chem. (1996), 437 as well as R. Wagner, L. Richter, Y. Wu, J. Weissmüller, A. Kleewein.

E. Hengge, Appl. Organomet. Chem. 12 (1998), 265, saccharide-modified siloxane derivatives having available two silicon groups moving independently of each other are described. No statements were made with regard to suitability as textile softeners or for finishing other surfaces. Furthermore, it was felt to be disadvantageous to have to include the step of saccharin addition into the synthetic process.

It is therefore the objective of the present invention to make available structures which do not have the disadvantages of the state of the art.

The objective was accomplished by compounds composed of two independently mobile siloxane groups and a connecting amine or ammonium element.

The objective is accomplished in accordance with the invention through monoquaternary or polyquaternary polysiloxane derivatives of the general formula (I):

S—K-Q¹-K—S (I)

where
S

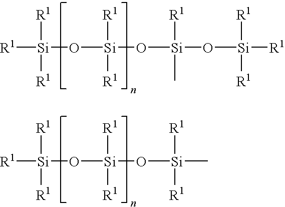

or
R¹ C₁-C₂₂-Alkyl, C₁-C₂₂-Fluoroalkyl or Aryl,
n 0 to 1000,
Q¹ a secondary amine structure

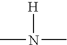

or tertiary amine structure

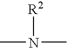

or quaternary ammonium structure

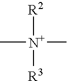

R² represents a branched or bivalent straight chain, cyclical or branched C₁-C₃₀-hydrocarbon radical, which is interrupted by —O—, —NH—C(O)—, —C(S)— and can be substituted with —OH or represents a single bond to the K radical,
R³ a simple straight chain, cyclical or branched C₁-C₃₀-hydrocarbon radical, which is interrupted by —O—, —NH—C(O)—, —C(S)— and can be substituted with —OH or an -A-E structure with
A —CH₂C(O)O—, CH₂CH₂C(O)O— or —CH₂CH₂CH₂C(O)O and
E a polyalkylene oxide group of the following structure

—[CH₂CH₂O]_{q}—[CH₂CH(CH₃)O]ᵣ—R⁴
q 1 to 200
r 0 to 200,
R⁴ corresponds to H, straight chain, cyclical or branched C₁-C₂₀-hydrocarbon radical, which is interrupted by —O—, or —C(O)— and can be substituted with —OH and can be acetyleneic, olefinic or aromatic, whereby, when a number of R³ radicals in the molecule are present, these can be the same or different, as well as
K is a bivalent or trivalent straight chain, cyclical or branched C₂-C₄₀-hydrocarbon radical, which is interrupted by —O—, —NH—, —N R¹—

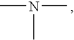

—C(O)—, —C(S)—
   and can be substituted by —OH, or contain a group Q², with
Q² secondary amine structure

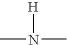

or tertiary amine structure

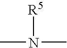

or quaternary ammonium structure

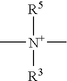

R⁵ a monovalent or bivalent straight chain, cyclical or branched C₁-C₂₀-hydrocarbon radical, which can be interrupted by —O—, —NH—C(O)—, —C(S)— and substituted by —OH, where the free valence of the bivalent radical R⁵ can bind to Q¹,
and when a majority of radicals K occur in the polysiloxanes, these can be identical or different from one another.

In one embodiment of the invention, polysiloxane compounds were prepared according to the Formula (I′):

S—K-Q¹-K—S (I′)

wherein
S
   S

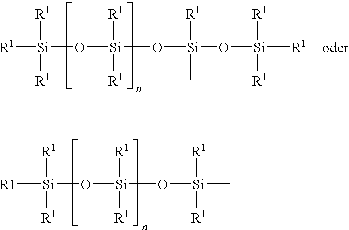

R¹ C₁-C₂₂-Alkyl, C₁-C₂₂-Fluoroalkyl or Aryl,
n 0 to 1000
Q¹ secondary amine structure

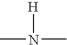

or tertiary amine structure

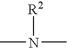

or quaternary ammonium structure

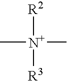

R² a monovalent or bivalent straight chain, cyclical or branched C₁-C₃₀-hydrocarbon radical, which can be interrupted by —O—, —NH—C(O)—, —C(S)— and substituted with —OH, or has a single bond with K,
R³ a monovalent straight chain, cyclical or branched C₁-C₃₀-hydrocarbon radical, which can be interrupted by —O—, —NH—C(O)—, —C(S)— and substituted by —OH, or by an -A-E-, structure.
A —CH₂C(O), —CH₂CH₂C(O)— or —CH₂CH₂CH₂C(O)O— and
E a polyalkylenoxide entity of the following structure

—[CH₂CH₂O]_{q}—[CH₂CH(CH₃)O]ᵣ—R⁴
q 1 to 200,
r 0 to 200,
R⁴ H, straight chain, cyclical or branched C₁-C₂₀-hydrocarbon radical, which is interrupted by —O—, or —C(O)— and can be
   substituted by —OH and can be acetyleneic, olefinic or aromatic, as well as
K a bivalent or trivalent straight chain, cyclical or branched C₂-C₄₀-hydrocarbon radical, which is interrupted by —O—, —NH—, —N R¹—, —N—, —C(O)—, —C(S)— and can be substituted by —OH, or contain a group Q², with
   Q² secondary amine structure

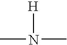

or tertiary amine structure

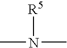

or quaternary ammonium structure

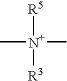

R⁵ a monovalent or bivalent straight chain, cyclical or branched C₁-C₂₀-hydrocarbon radical, which can be interrupted by —O—, —NH—C(O)—, —C(S)— and substituted with —OH, or a has single bond to Q¹, or
R² and R⁵—CH₃, —CH₂CH₃, —(CH₂)₂CH₃, —(CH₂)₃CH₃, —(CH₂)₅CH₃, —CH₂CH₂OH,

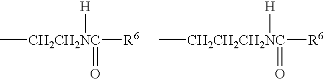

R⁶ a monovalent straight chain, cyclical or branched C₁-C₁₈-hydrocarbon radical, which can be interrupted by —O—, —NH—, —C(O)—, —C(S)— and substituted by —OH.

The possibility a trivalent substructure for K means that K can be branched, and hence can participate with two compounds in the quaternation of Q¹ over the bivalent radical R².

The possibility of a bivalent substructure for R² means that it in these cases, it is a question of a structure forming a cyclical system, in which process R² is then a single bond to K, especially to one exhibiting tertiary amine structure, or to a quaternary structure Q² over R⁵.

In a further embodiment, the present application signifies R¹ C₁-C₁₈-alkyl, C₁-C₁₈-fluoroalkyl and aryl, and the radicals n, R², R³, R⁴, R⁵, R⁶, K, A, 3E, Q¹, Q², q and r, have the aforementioned meaning.

In a further embodiment, the present application signifies R¹ C₁-C₁₈-alkyl, C₁-C₆-fluoroalkyl and aryl, and the radicals n, R², R³, R⁴, R⁵, R⁶, K, A, 3E, Q¹, Q², q and r, have the aforementioned meaning.

In further embodiment, the present application signifies R¹ C₁-C₆-Alkyl, C₁-C₄-fluoroalkyl and phenyl, and the radicals n, R², R³, R⁴, R⁵, R⁶, K, A, 3E, Q¹, Q², q and r, have the aforementioned meaning.

In further embodiment, the present application signifies R¹ methyl, ethyl, trifluoropropyl and phenyl, and the radicals n, R², R³, R⁴, R⁵, R⁶, K, A, 3E, Q¹, Q², q and r, have the aforementioned meaning.

In a further embodiment of the present application, K signifies a bivalent or trivalent straight chain, cyclical or branched C₂-C₃₀-hydrocarbon radical, which is interrupted by —O—, NH—, —NR¹—,

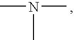

—C(O)—, —C(S)— and can be substituted by —OH, or contain a group Q², and the radicals n, R², R³, R⁴, R⁵, R⁶, K, A, 3E, Q¹, Q², q and r, have the aforementioned meaning.

In a further embodiment of the present application, n means 0 to 100, preferably 0 to 80 and especially preferably 10 to 80, and the radicals R¹, R², R³, R⁴, R⁵, R⁶, K, A, 3E, Q¹, Q², q and r, have the aforementioned meaning.

In a further embodiment of the present application, q means 1 to 50, preferably 2 to 50, and the radicals R¹, R², R³, R⁴, R⁵, R⁶, K, A, 3E, Q¹, Q², q and r, have the aforementioned meaning.

In a preferred embodiment of the present application, q would be 2 to 20 and especially favored 2 to 10 and the radicals R¹, R², R³, R⁴, R⁵, R⁶, K, A, 3E, Q¹, Q², n and r, have the aforementioned meaning.

In a further embodiment of the present application, r means 0 to 100, preferably 0 to 50 and the radicals R¹, R², R³, R⁴, R⁵, R⁶, K, A, 3E, Q¹, Q², q and n, have the aforementioned meaning.

In a further preferred embodiment of the present application, r means 0 to 20 and especially preferably 0 to 10, and the radicals R¹, R², R³, R⁴, R⁵, R⁶, K, A, 3E, Q¹, Q², q and n, have the aforementioned meaning.

In a further embodiment of the present application, R² and R⁵ signify —CH₃, —CH₂CH₃, —(CH₂)₂CH₃, —(CH₂)₃CH₃, —(CH₂)₅CH₃, —CH₂CH₂OH,

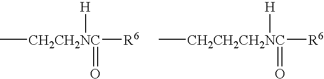

with R⁶ a monovalent straight chain, cyclical or branched, C₁-C₁₈-hydrocarbon radical, which can be interrupted by —O—, —NH—, —C(O)—, —C(S)— and substituted by —OH.

In a further embodiment of the present application, R³ signifies —CH₃, —CH₂CH₃, —(CH₂)₂CH₃, —(CH₂)₃CH₃, —(CH₂)₅CH₃, —CH₂CH₂OH,

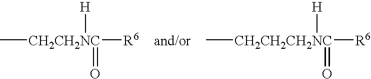

wherein R⁶ is a monovalent straight chain, cyclical or branched, C₁-C₁₈-hydrocarbon radical, which can be interrupted by —O—, —NH—, —C(O)—, —C(S)— and substituted by —OH.

In a further preferred embodiment of the present application, R⁴ means a bivalent or trivalent straight chain, cyclical or branched C₁-C₁₈-hydrocarbon radical, which can be interrupted by —O—, —NH—C(O)—, —C(S)— and can be substituted with —OH, or make a single bond with Q¹, and the radicals n, R¹, R², R³, R⁵, R⁶, K, A, 3E, Q¹, Q², q and r, have the aforementioned meaning.

In a further preferred embodiment, R⁴ means C₁-C₆-alkyl, —CH₂CH═CH₂, —CH₂CH(OH)CH₂OCH₂CH═CH₂, —CH₂C≡CH, —C(O)CH₃, —C(O)CH₂CH₃ and the radicals n, R¹, R², R³, R⁵, R⁶, K, A, 3E, Q¹, Q², q and r, have the aforementioned meaning.

In a further preferred embodiment, K means

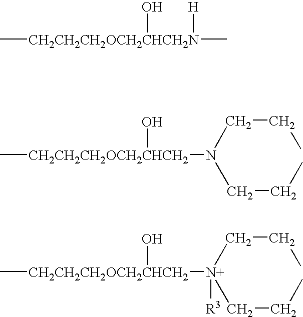

and the radicals n, R¹, R², R³, R⁵, R⁶, K, A, 3E, Q¹, Q², q and r, have the aforementioned meaning.

In a further preferred embodiment of the present invention, R⁶ means unsubstituted C₅-C₁₇-hydrocarbon radicals, which are derived from the corresponding saturated or unsaturated fatty acids, and the radicals n, R¹, R², R³, R⁵, R⁶, K, A, 3E, Q¹, Q², q and r, have the aforementioned meaning.

In the context of the present invention, the concept of “C₁-C₂₂-Alkyl or C₁-C₃₀-hydrocarbon radical” means aliphatic hydrocarbon compounds with 1 to 22 carbon atoms or 1 to 30 carbon atoms which might be in a straight chain or branched. Cited by way of example are methyl, ethyl, propyl, n-butyl, pentyl, hexyl, heptyl, nonyl, decyl, undecyl, isopropyl, neopentyl, and 1,2,3 trimethylhexyl.

In the framework of the present invention, the concept of “C₁-C₂₂-Fluoralkyl” means aliphatic hydrocarbon compounds with 1 to 22 carbon atoms which might be straight or branched, in which at least one fluorine atom is substituted. Examples cited are monofluoromethyl, monofluoroethyl, 1,1,1-trifluoroethyl, perfluoroethyl, 1,1,1-trifluoropropyl, 1,2,2-trifluorobutyl.

Within the framework of the invention, the concept “aryl” means unsubstituted phenyl, or phenyl substituted one or more times by OH, F, CL, CF₃, C₁-C₆-alkyl, C₁-C₆-alkoxy, C₃-C₇-cycloalkyl C₂-C₆-alkenyl or phenyl. The expression can also mean naphthyl if necessary.

A further object of the present invention is to make available a process for the production of the compounds of the general formula (I) or (I′).

The point of departure for the synthesis in accordance with the invention compounds is monofunctional H-siloxane of the general structure

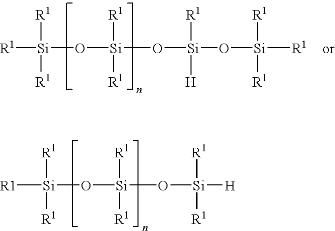

where R¹ and n have the meanings given above. Since these compounds are not commercially available, these siloxanes, especially the longer-chain derivatives, can be manufactured according to known procedures (Silicone, Chemie und Technologie, Vulkan-Verlag, Essen 1989, pp. 82-84).

The acid-catalyzed equilibriation of trimethylsilyl-terminated siloxanes, for example, hexamethyldisiloxane (MM), with dimethylsiloxy-rich compounds, for example octamethylcyclotetrasiloxane (D₄), [takes place] in the presence of a corresponding mixture containing SiH, but not a siloxane deriving from SiH delivered product, in which the SiH function is located within the chain. In the equilibriation balance all the relevant products are formed, which per molecule have available either none, or more than one SiH function.

The acid catalyzed equilibriation of the α-SiH compounds, for example pentamethyldisiloxane (MM^{H}) with dimethylsiloxane-rich compounds, or for example octamethylcyclotetrasiloxane (D₄) delivers monofunctional products with terminal SiH function. Pentamethyldisiloxane can for example be substituted by equimolar mixtures of hexamethyldisiloxane (MM) and tetramethyldisiloxane (M^{H}M^{H}). In equilibriation balance there are additional products formed, which per molecule have none or two terminal SiH functions.

The equilibriation of cyclic siloxanes, such as hexamethylcyclotrisiloxane (D₃) or octamethylcyclotetrasiloxane (D₄) with alkaline trimethyl silanolates, e.g., potassium trimethyl silanolate, produces oligo siloxanolates, which react with dimethylchlorosilane with the corresponding monofunctional compounds with terminal SiH function. In the equilibriation balance, additional products are formed, which per molecule have available either none, or only two terminal silanolate functions. In consequence, there are also products present which have available none, or two terminal SiH functions.

In the framework of the invention, there were described, besides strictly defined monofunctional compounds, also mixtures, treated as monofunctional SiH compounds.

Reactive, alkylating, monofunctional siloxane compounds are synthesized through hydrosilylation by, for example, halogenated alkyls, especially allylic chloride and allylic bromide, unsaturated carboxylic haloacid esters, preferably chloroacetic acid allylic esters, chloroacetic acid propargyl esters and 3-chloropropionic acid allylic esters and epoxy-functional alkenes, for example vinylcyclohexenoxide and allylic glyco ether, with the here described monofunctional SiH compounds. Hydrosilylation in general, with the substances from the cited groups, is likewise known (B. Marciniec, Comprehensive Handbook on Hydrosilylation, Pergamon Press, Oxford 1992, p. 116-121, 127-130, 134-137, 151-155). The subsequent synthesis of compounds having secondary amine functions of the types ABA (ABA [cut off] means that two polysiloxane groups are bonded by a bridging amino- or ammonium structure) whose general structure is

S—K-Q¹-K—S
in which

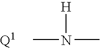

K and S have the aforementioned meanings, occurs preferably through alkylization of two primary amine exhibiting amino groups, for example α,ω-alkylenediamines, preferably ethylenediamine, 1,3-propylenediamine, 1,6-hexylenediamine, short-chain ethylenoxide/propylenoxide groups containing diprimary amines, especially Jeffamine® (Huntsman Corp.) of the type Jeffamine EDR 148, Jeffamine ED 600, Jeffamine D 230, Jeffamine D 400, with reactive, alkylating, in the sense of the invention, monofunctional siloxane intermediate products. The stochiometry of the reaction between the diprimary amine and the monofunctional siloxane has a ratio of 1:2.

The synthesis of tertiary amine functions containing ABA type compounds of the general structure

S—K-Q¹-K—S
in which

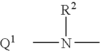

K and S have the aforementioned meanings, occurs preferably in two ways. On the one hand, it is possible to first of all directly bind the secondary amine function containing unsaturated structures, for example, N=methylallyl amine or CH₂═CHCH₂OCH₂CH(OH)CH₂NHCH₃, through hydrosilylation, to the monofunctional Si—H siloxane. This process is generally known, and is, for example, described by B. Marciniec, Comprehensive Handbook on Hydrosilylation, Pergamon Press, Oxford 1992, pp. 122-124).

These secondary amine structures that are produced, can be transformed in a following step, using reactive alkylation siloxane intermediates, into polymers containing tertiary amine structures. The stochiometry of this reaction has a ratio of aminosiloxane to monofunctional siloxane of about 1:1.

As an alternative to the step-wise synthesis detailed above, it is possible to produce tertiary amine functionalized polymers in one reaction step. The point of departure for this is in the handling of the reactive, alkylation siloxane intermediate steps, preferably the epoxy derivative, especially the allylic glycide ether species. This might be transformed, by reacting with primary amines, for example methylamine, in a molar ratio of preferably 2:1 into tertiary amines.

It is also possible to use difunctional secondary amines, for example piperazine, for this reaction. In this case, molar ratio of the secondary amine group to the alkylation group, preferably to one epoxy group, would be preferably 1:1. Among the results of carrying out such reactions, products were obtained in which two tertiary amine groups are to be found between the two siloxane blocks.

The synthesis of monoquaternary or polyquaternary polysiloxanes of the types ABA of the general structure

S—K-Q¹-K—S
in which
   Q¹ means

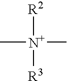

Occurs in various ways beginning with tertiary amino function-bearing siloxane derivatives. On the one hand, transforming the above-described reactants, monofunctional siloxane derivatives, preferably the epoxy functional derivatives, into tertiary amines is preferred, using secondary amines, for example, dimethyl amine or morpholine which then in a follow-up step would react with a second mole of reactive, monofunctional siloxane compound to the quaternary products. For both reaction steps, the preferred molar ratio is 1:1.

The application of secondary-tertiary diamines opens the possibility of creating regioselective combinations of tertiary amines and quaternary structures. The alkylation of amines of types N-methylpiperazine with preferably one mole epoxy-functional siloxane produces ditertiary aminosiloxane, which for example, are quaternated from a second mole of reactive, monofunctional siloxane compounds, for example a halogen carboxylic acid ester derivative, into methylated nitrogen atoms. A surplus of the reactive, monofunctional siloxane compounds, or an addition of a further alkylation agent, leads to an incipient alkylation of the second nitrogen atom.

The secondary amines, produced by alkylation, for example dimethylamine, or secondary-tertiary diamines, for example N-methylpiperazine, with preferably one mole epoxy-functional siloxane accessible tertiary or ditertiary aminosiloxanes, might in a preferred embodiment with difunctional alkylation agents in a molar ratio 2:1. As a result of such a reaction, two quaternary ammonium groups, or two quaternary ammonium groups in the neighborhood, in any given case of a tertiary amine group, are bonded with each other over a single-chained spacer. Dihalogen-alkanes, diepoxy-compounds in the presence of acids, α,ω-dihalogen oligoalkylene oxides or dihalogen carboxylic acid esters of alkylene oxides are suitable alkylation substances for this purpose.

Preferred starting materials for α,ω-dihalogen alkylene oxides and dihalogen carboxylic acid esters are lower molecular oligomers and polymers, alkylene oxide of the general compound

HO[CH₂CH₂O]_{q}—[CH₂CH(CH₃)O]ᵣH

in which q and r have the aforementioned meanings. Preferred reactants are diethyleneglycol, triethyleneglycol, tetraethyleneglycol, the oligoethyleneglycols with a molecular weight of 300 to 1000 g/mole, preferably, 400, 600, and 800, as well as dipropyleneglycol. α,ω-dihalogenalkylene oxides can be produced in the usual way, e.g. through halogenation with thionyl chloride.

Esterization takes place in the familiar way (Organikum, Organisch-chemisches Grundpraktikum [Organikum: Organic Chemistry Basic Practical Course], 17. Auflage, VEB Deutscher Verlag der Wissenschaften, Berlin 1988, pp. 402-408), through reaction with C₂-C₄ carboxylic haloacids, their anhydrides, or acid chlorides.

The process described in the present document, primarily based in piperazine-based derivatives with two tertiary amino groups between two siloxane blocks, can also be transferred to quaternary ammonium salts. The degree is quaternation is steered by the molar ratio of the two tertiary amino groups, which are bonded between the two siloxane blocks, to the alkylation agents. It is preferable, when working on an equimolar basis, to synthesize products, in which all the tertiary amines are transformed into quaternary ammonium functions. On the other hand, it can be advantageous to preserve a part of the tertiary amine functions through the selective deficiency in alkylation agents to preserve a part of the tertiary amine functions.

Examples of advantageous alkylation agents are epoxy derivatives in the presence of acids, alkyl halogenides or carboxylic haloacid esters, preferably carboxylic haloacid esters with alkylene oxide.

Preferred starting materials for these alkylations means are lower molecular, oligomer and polymer alkylene oxides of the general compound

HO[CH₂CH₂O]_{q}—[CH₂CH(CH₃)O]ᵣR⁴

where q, r and R⁴ is as cited above. Preferred reactants are the corresponding monosubstituted derivatives of diethylene glycol, triethylene glycol, tetraethylene glycol, the oligoethylene glycols with molar weight of 300 to 1000 g/mole, preferably 400, 600, and 800, as well as dipropylene glycol. The production of these ethers and esters takes place in a known manner by acid- or alkali catalyzed addition of ethylene oxide and/or propylene oxide with the corresponding alcohol (Organikum, Organisch-chemisches Grundpraktikum, 17. Auflage, VEB DeutscherVerlag der Wissenschaften, Berlin 1988, p. 259; U.S. Pat. No. 5,625,024) or carboxylic acids (E. Sung, W. Umbach, H. Baumann, Fette Seifen Anstrichmittel [Fats, Soaps, Paints] 73, 88 [1971]).

The following syntheses of carboxylic haloacid esters follow the known manner (Organikum, Organisch-chemisches Grundpraktikum, 17. Auflage, VEB Deutscher Verlag der Wissenschaften, Berlin 1988, pp. 402-408) through reaction with the C₂-C₄-halogen-carboxylic acids, whose anhydrides or acid chlorides. The selective synthesis of hydroxyfunctional carboxylic haloacid esters, in which R⁴ stands for hydrogen, is attained by the addition of ethylene oxide and/or propylene oxide to the corresponding carboxylic haloacids under acid conditions.

When more than one tertiary amino function is introduced between the siloxane blocks, e.g., through piperazine structures, it becomes possible to bring to bear the hydrophilic and the surfactant properties within broader limits, through the relationship of the tertiary amines to the quaternary structure. It lies within the framework of the invention, to bring about a reaction of a number of siloxane components and/or alkylation agents while maintaining the desired general overall stochiometry. This opens up the possibility, for example, of creating a desired length of siloxane chain, employing a single siloxane component, or otherwise through the selective mixing of several siloxane components.

Anions coming into consideration are primarily those which were formed during the quaternation of halogenated iodides, especially chloroiodide. Other anions can also be employed through ion exchange reactions.

Examples cited are organic anions, such as carboxylates, sulfonates, sulfates, polyethercarboxylates and polyethersulfates.

Alkylation reactions are preferably carried out in polar organic solvents. Suitable for this are for example alcohols from the group consisting of methanol, ethanol, i-propanol and n-butanol; glycols form the group consisting of ethylene glycol, diethylene glycol, triethylene glycol, methyl-, ethyl- and butylether of the cited glycols, 1,2-propylene glycol, and 1,3-propylene glycol, ketones such as acetone, and methylethylketone, esters, such as ethylacetate, butylacetate and 2-ethylhexylacetate, ethers such as tetrahydrofuran and nitro-compounds, such as nitromethane. The choice of solvents is focussed essentially on the solubility of the reaction partner, and the target reaction temperature. The reactions take place in the range of 20° C. to 130° C., preferably 40° C. to 100° C.

Products of the invention combining the softening of the characteristics of the siloxane structures and the tendency of amino structures or quaternary, ammonium groups to adsorption on negatively charged solid-body-surfaces, might be successfully used in cosmetic formulations for skin- and hair-care, in cleaning agents for treating and handling hard surfaces, in formulas for drying automobiles and other hard surfaces after machine-washing, for use with textiles and textile phases, as a separate softener after the washing of textiles with non-ionic or anionic/non-ionic detergent formulas, as a softener in non-ionic or anionic/non-ionic washing of textiles based on tenside formulas.

Along with this, amino derivatives might be used, depending on the pH value, in the form of amine or amine salts.

The invention concerns the broadening of the application of the polysiloxane compounds described herein, in cosmetic formulas for skin- and hair care, in cleaning agents for treating and handling hard surfaces, in formulas for drying automobiles and other hard surfaces, for example, after machine-washing, for use with textiles and textile phases, as a separate softener after the washing of textiles with non-ionic or anionic/non-ionic detergent formulas, as softeners for non-ionic or anionic/non-ionic washing of textiles based on tenside formulas, as well as a means for preventing or reversing textile wrinkling.

The invention regards the broader application of the herein-described polysiloxane compounds as wash-resistant hydrophilic softeners for initial textile finishing.

Further, the invention concerns compounds containing at least one polysiloxane compound together with at least one additional ingredient typical for the composition.

Below there are given some typical examples of compositions of this type in which the polysiloxane compounds of the invention can be employed with advantage.

Typical catalysts in such kinds of compounds are for example, the substances, which are described in A. Domsch: Die kosmetischen Präparate [Cosmetic Preparations], Vol. I and II, 4^{th} edition. Verl. für chem. Industrie, H. Ziolkowsky K G, Augsburg, as well as the International Cosmetic Ingredient Dictionary and Handbook 7^{th} Edition 1997, by J. A. Wenninger, G. N. McEwen Vol. 1-4, by The Cosmetic, Toiletry and Fragrance Association of Washington D.C. or under http://www.cosmetic-world.com/inci/Incialf.htm.

### Anionic Shampoo.

The formulation given here is conceived of as a basic formulation. Anionic shampoos usually contain the following ingredients, without being limited to them:

Alkylsulfate, alkylethersulfate, sodium lauryl sulfate, sodium lauryl ether sulfate, ammonium lauryl sulfate, ammonium lauryl ether sulfate, TEA-laurylsulfate, TEA-lauryl-ethersulfate, alkyl benzol sulfonate, α-olefinsulfonate, paraffinsulfonate, sulfosuccinate, N-acyl tauride, sulfate-glyceride, sulfated alkalonamide, carboxylate salts, N-acyl-amino-acid-salts, silicones, etc.

| Components | % |
|---|---|
| Ammonium lauryl sulfate | 10.00-30.00 |
| Ammonium lauryl ether sulfate | 5.00-20.00 |
| Cocamidopropyl betaine | 0.00-15.00 |
| Lauramide DEA | 0.00-5.00 |
| Cocamide Mea | 0.00-5.00 |
| Dimethicone copolyol | 0.00-5.00 |
| (dimethylsiloxane glycol polymer) | |
| Cyclopentasiloxane | 0.00-5.00 |
| Polysiloxane compound | 0.50-5.00 |
| of the invention | |
| Polyquaternium-10 | 0.00-2.00 |
| Preservatives | 0.00-0.50 |
| Scents | 0.00-5.00 |
| Deionized water | q.s. 100% |
| Sodium chloride | q.s. |

### Non-Ionized Shampoo

The composition example is intended as a basic formulation. Non-ionized shampoos, generally speaking, contain (without being limited to) the following components:

Monoalkanolamides, monoethanolamides, monoisopropanolamides, polyhydroxy derivatives, sucrose monolaurate, polyglycerin ester, amino oxides, polyethoxylated derivatives, sorbitan derivatives, silicone, etc.

| Components | % |
|---|---|
| Lauramide DEA | 10.00-30.00 |
| Lauramide oxide | 5.00-20.00 |
| Cocamide Mea | 0.00-5.00 |
| Dimethicone copolyol | 0.00-5.00 |
| Polysiloxane compound | 0.50-5.00 |
| of the invention | |
| Preservatives | 0.00-0.50 |
| Scents | 0.00-5.00 |
| Deionized water | q.s. 100% |
| Sodium chloride | q.s. |

### Amphoteric Shampoo

The composition example is intended as a basic formulation. Formulas of this category, generally speaking, contain (without being limited to) the following components:

N-alkyl-iminodipropionate, n-alkyl-iminopropionate, amino acids, amino acid derivatives, amino betaines, imidazolinium derivatives, sulfobetaine, sultaine, betaine, silicone, etc.

| Components | % |
|---|---|
| PEG-80 sorbitan laurate | 10.00-30.00 |
| Lauroamphoglycinate | 0.00-10.00 |
| Cocamidopropyl hydroxysultaine | 0.00-15.00 |
| PEG-150 distearate | 0.00-5.00 |
| Lauryl ether-13 carboxylate | 0.00-5.00 |
| Polysiloxane compound | 0.50-5.00 |
| of the invention | |
| Scents | 0.00-5.00 |
| Deionized water | q.s. 100% |
| Sodium chloride | q.s. |

### Cationic Shampoo

The composition example is intended as a basic formulation. Formulas of this category, generally speaking, contain (without being limited to) the following components:

Bis-quaternary ammonium compounds, bis-(trialkyl ammonium acetyl) diamine, amidoamine, ammonium alkyl ester, silicone, etc.

| Components | % |
|---|---|
| Lauryl ether-13 carboxylate | 10.00-30.00 |
| Isopropyl myristate | 5.00-20.00 |
| Cocamidopropyl betaine | 0.00-15.00 |
| Lauramide DEA | 0.00-5.00 |
| Cocamide Mea | 0.00-5.00 |
| Polysiloxane compound | 0.50-5.00 |
| of the invention | |
| Preservatives | 0.00-0.50 |
| Scents | 0.00-5.00 |
| Deionized water | q.s. 100% |
| Sodium chloride | q.s. |

### Solidifying Agents

The composition example is intended as a basic formulation. Formulas of this category, generally speaking, contain (without being limited to) the following components:

Fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, etc.

| Components | % |
|---|---|
| Ceteareth-20 | 0.10-10.00 |
| Steareth-20 | 0.10-10.00 |
| Stearyl alcohol | 0.10-10.00 |
| Stearamidopropyl dimethylamine | 0.00-10.00 |
| Dicetyl dimonium chloride | 0.00-10.00 |
| Polysiloxane compound | 0.50-5.00 |
| of the invention | |
| Cyclopentasiloxane | 0.00-5.00 |
| Dimethicone | 0.00-5.00 |
| Preservatives | 0.00-0.50 |
| Scents | 0.00-5.00 |
| Deionized water | q.s. 100% |

### “Clear Rinse Off” Solidifying Agents

The composition example is intended as a basic formulation. Formulas of this category, generally speaking, contain (without being limited to) the following components:

Fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, etc.

| Components | % |
|---|---|
| Glycerin | 0.10-10.00 |
| Cetrimonium chloride | 0.00-10.00 |
| Polysiloxane compound | 0.50-5.00 |
| of the invention | |
| Hydroxy ethyl cellulose | 0.00-5.00 |
| Preservatives | 0.00-0.50 |
| Scents | 0.00-5.00 |
| Deionized water | q.s. 100% |

### Solidifying Agents for Hair

The composition example is intended as a basic formulation. Formulas of this category, generally speaking, contain (without being limited to) the following components:

Fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, solvents, ethanol, isopropanol, isoparaffin solvents, butane, propane, isobutane, CFCs, fluorinated aerosol propellants, dimethyl ether, compressed gases, etc.

| Components | % |
|---|---|
| Polysiloxane compound | 0.50-5.00 |
| of the invention | |
| Nonoxynol-15 | 0.00-2.00 |
| Nonoxynol-20 | 0.00-2.00 |
| Scents | 0.00-5.00 |
| Aerosol propellants | 0.00-20.00 |
| Preservatives | 0.00-0.50 |
| Deionized water | q.s. 100% |

### Pump Spray (Solidifying Agent) for Hair

The composition example is intended as a basic formulation. Formulas of this category, generally speaking, contain (without being limited to) the following components:

Fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, solvents, ethanol, isopropanol, isoparaffin solvents, etc.

| Components | % |
|---|---|
| Polysiloxane compound | 0.50-5.00 |
| of the invention | |
| Cyclomethicone | 0.00-80.00 |
| Ethanol | 0.00-80.00 |
| Preservatives | 0.00-0.50 |
| Scents | 0.00-5.00 |
| Deionized water | q.s. 100% |

### Solidifying Agent Spray for Hair

The composition example is intended as a basic formulation. Formulas of this category, generally speaking, contain (without being limited to) the following components:

Fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, solvents, ethanol, isopropanol, isoparaffin solvents, butane, propane, isobutane, CFCs, fluorinated aerosol propellants, dimethyl ether, compressed gases, etc.

| Components | % |
|---|---|
| Polysiloxane compound | 0.50-5.00 |
| of the invention | |
| Cyclomethicone | 0.00-80.00 |
| Ethanol | 0.00-50.00 |
| Aerosol propellants | 0.00-50.00 |
| Preservatives | 0.00-0.50 |
| Scents | 0.00-5.00 |
| Deionized water | q.s. 100% |

### Gel Solidifying Agents for Hair

The composition example is intended as a basic formulation. Formulas of this category, generally speaking, contain (without being limited to) the following components:

Thickening agents, cellulose derivatives, acryl acid derivatives, fixative polymers, conditioning chemicals, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, silicone, solvents, ethanol, isopropanol, isoparaffin solvents, etc.

| Components | % |
|---|---|
| Polysiloxane compound | 0.50-5.00 |
| of the invention | |
| Hydroxyethyl cellulose | 0.00-2.00 |
| Scents | 0.00-5.00 |
| Preservatives | 0.00-0.50 |
| Citric acid | 0.00-2.00 |
| Deionized water | q.s. 100% |

### Styling Gel for Hair

The composition example is intended as a basic formulation. Formulas of this category, generally speaking, contain (without being limited to) the following components:

Fixative polymers, lacquer, acryl acid derivatives, cellulose derivatives, vinyl derivatives, conditioning chemicals, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, solvents, ethanol, isopropanol, isoparaffin solvents, etc.

| Components | % |
|---|---|
| Polysiloxane compound | 0.50-5.00 |
| of the invention | |
| Fixatives | 0.10-10.00 |
| Hydroxy ethyl cellulose | 0.00-2.00 |
| Scents | 0.00-5.00 |
| Citric acid | 0.00-2.00 |
| Deionized water | q.s. 100% |

### Styling Spray for Hair

The composition example is intended as a basic formulation. Formulas of this category, generally speaking, contain (without being limited to) the following components:

Fixative polymers, lacquer, vinyl derivatives, fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, solvents, ethanol, isopropanol, isoparaffin solvents, butane, propane, isobutane, CFCs, fluorinated aerosol propellants, dimethyl ether, compressed gases, etc.

| Components | % |
|---|---|
| Polysiloxane compound | 0.50-5.00 |
| of the invention | |
| Cyclomethicone | 0.00-80.00 |
| Fixatives | 0.10-10.00 |
| Ethanol | 0.00-50.00 |
| Aerosol propellants | 0.00-50.00 |
| Preservatives | 0.00-0.50 |
| Scents | 0.00-5.00 |
| Deionized water | q.s. 100% |

### Pump Spray (Styling) for Hair

The composition example is intended as a basic formulation. Formulas of this category, generally speaking, contain (without being limited to) the following components:

Vinyl derivatives, fixative polymers, lacquer, fatty acids, fatty acid esters, ethyloxylated fatty acids, ethyloxylated fatty acid esters, fatty alcohols, ethyloxylated fatty alcohols, glycols, glycol esters, glycerin, glycerin esters, lanolin, lanolin derivatives, mineral oil, petrolatum, lecithin, lecithin derivatives, waxes, wax derivatives, cationic polymers, proteins, protein derivatives, amino acids, amino acid derivatives, humectants, thickening agents, silicone, solvents, ethanol, isopropanol, isoparaffin solvents, butane, propane, isobutane, CFCs, fluorinated aerosol propellants, dimethyl ether, compressed gases, etc.

| Components | % |
|---|---|
| Polysiloxane compound | 0.50-5.00 |
| of the invention | |
| Fixatives | 0.10-10.00 |
| Cyclomethicone | 0.00-80.00 |
| Ethanol | 0.00-50.00 |
| Preservatives | 0.00-0.50 |
| Scents | 0.00-5.00 |
| Deionized water | q.s. 100% |

The use of polysiloxane derivatives of the invention, when applied in the area of hair cosmetics, leads to favorable effects with regard to setting, sheen, hold, body, volume, moisture regulation, color retention, protection against the effects of the environment (UV, salt water, etc.), capacity for reshaping, anti-static properties, capacity for dyeing, etc.

### EXAMPLES

The following examples serve to explain the present invention in greater detail, but without limiting it in any way.

### Example 1

1a) 3.37 g (0.1 mol) of an epoxysiloxane with the formula

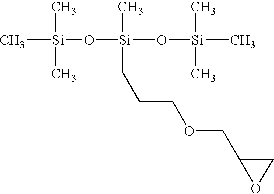

and 10.1 g (0.1 mol) n-methyl piperazine were dissolved in 40 ml i-propanol and heated at reflux temperature for 7 hours. The solvent was distilled off, following the conclusion of the reaction, in a water jet vacuum and then in an oil pump vacuum. 39 g of a clear, light brown fluid of the following structure:

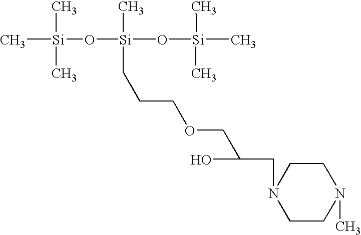

were obtained. According to a gas chromatography analysis, the epoxide was quantitatively transferred into the piperazine derivative.

1b) 497 g (8.87 mol) CH CCH₂OH were placed under nitrogen at room temperature. Under intensive agitation, 955 g (8.45 mol) chloroacetic acid chloride was dripped in over 1 hour. During the dripping process, the temperature increased to 60° C. and intensive HCl development took place. The preparation took on a black color. After the conclusion of the dripping process, the preparation was heated for 1 hour at 130° C. Fractionated distillation resulted in a principal yield of 891 g of a light yellowish oil with the structure CH CCH₂OC(O)CH₂Cl with a boiling point of 179-181° C. The purity of the ester, determined by gas chromatography, was 99%.

¹³C-NMR:

| | Shift |
|---|---|
| Substructure | (ppm) |
| ClCH₂C(O)OCH₂C CH | 40.4 |
| ClCH₂C(O)OCH₂C CH | 166.5 |
| ClCH₂C(O)OCH₂C CH | 53.1 |
| ClCH₂C(O)OCH₂C CH | 76.4 |
| ClCH₂C(O)OCH₂C CH | 75.6 |

1c) 26.5 g (0.2 mol) of the chloroacetic acid ester according to Example 1 b and 44 mg of a 3.43% Lamoreaux catalyst solution according to U.S. Pat. No. 3,220,972 were placed under nitrogen at room temperature. Over a period of 30 minutes, 48.8 g

(0.22 mol) 1,1,1,3,5,5,5 heptamethyl trisiloxane (M₂D^{H}) were dripped in and the temperature was increased to 60° C. Subsequently, the preparation was heated for 4 hours at 100° C. After distilling of all components which boiled at up to 120° C. and at 2 hPa, 64.5 g of a yellowish fluid were obtained. According to gas chromatography analysis, the product contained 85% target product

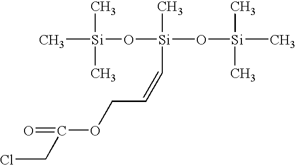

and 15% heptamethyl trisiloxane ester of chloroacetic acid.

¹³C-NMR of the Si—C linked target product

| Substructure | Shift (ppm) |
|---|---|
| ClCH₂C(O)OCH₂CH═CH—Si | 40.3 |
| ClCH₂C(O)OCH₂CH═CH—Si | 166.7 |
| ClCH₂C(O)OCH₂CH═CH—Si | 67.8 |
| ClCH₂C(O)OCH₂CH═CH—Si | 144.4 |
| ClCH₂C(O)OCH₂CH═CH—Si | 126.6 |

1d) 21.8 g (0.05 mol) of the siloxanyl modified piperazine derivative according to Example 1a) and 17.7 g (0.05 mol) of the chloroacetic acid ester derivative according to Example 1c) were absorbed in 50 ml methyl propyl ketone under nitrogen and heated for 6 hours at reflux temperature. Following the conclusion of the reaction, all components which boiled at up to 100° C. and at 4 hPa were removed under vacuum. 35.7 g of a ductile, brown mass of the following structure:

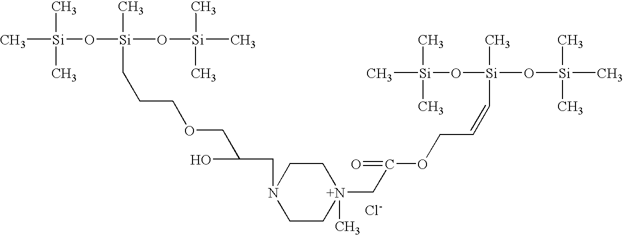

were obtained.

¹³C-NMR of the Si—C linked target product

| | Shift |
|---|---|
| Substructure | (ppm) |
| —CH(OH)CH₂NCH₂CH₂N⁺(CH₃)CH₂C(O)OCH₂CH═CH—Si | 65.7 |
| —CH(OH)CH₂NCH₂CH₂N⁺(CH₃)CH₂C(O)OCH₂CH═CH—Si | 51.2 |
| —CH(OH)CH₂NCH₂CH₂N⁺(CH₃)CH₂C(O)OCH₂CH═CH—Si | 46.4 |
| —CH(OH)CH₂NCH₂CH₂N⁺(CH₃)CH₂C(O)OCH₂CH═CH—Si | 60.3 |
| —CH(OH)CH₂NCH₂CH₂N⁺(CH₃)CH₂C(O)OCH₂CH═CH—Si | 52.8 |
| —CH(OH)CH₂NCH₂CH₂N⁺(CH₃)CH₂C(O)OCH₂CH═CH—Si | 61.0 |
| —CH(OH)CH₂NCH₂CH₂N⁺(CH₃)CH₂C(O)OCH₂CH═CH—Si | 169.0 |
| —CH(OH)CH₂NCH₂CH₂N⁺(CH₃)CH₂C(O)OCH₂CH═CH—Si | 66.5 |
| —CH(OH)CH₂NCH₂CH₂N⁺(CH₃)CH₂C(O)OCH₂CH═CH—Si | 144.1 |
| —CH(OH)CH₂NCH₂CH₂N⁺(CH₃)CH₂C(O)OCH₂CH═CH—Si | 126.0 |

### Example 2

2a) 238 g (2.24 mol) diethylene glycol were placed under nitrogen at room temperature. Under intensive agitation, 558 g (4.93 mol) chloroacetic acid chloride was dripped in over 1 hour. During the dripping process, the temperature increased to 82° C. and intensive HCl development took place. After the conclusion of the dripping process, the preparation was heated for 30 minutes at 130° C. Subsequently, all components which boiled at up to 130° C.

and at 20 hPa were removed. The result was 566 g of a light yellowish oil with the structure

ClCH₂C(O)OCH₂CH₂OCH₂CH₂OC(O)CH₂Cl

The purity of the ester, determined by gas chromatography, was 99.2%.

¹³C-NMR:

| Substructure | Shift (ppm) |
|---|---|
| ClCH₂— | 40.7 |
| ClCH₂C(O)— | 167.1 |
| ClCH₂C(O)OCH₂— | 65.2 |
| ClCH₂C(O)OCH₂CH₂— | 68.6 |

2b) 21.8 g (0.05 mol) of the siloxanyl modified piperazine derivative according to Example 1a) and 6.46 g (0.025 mol) of the chloroacetic acid ester derivative according to Example 2a) were dissolved in 100 ml i-propanol and heated at reflux temperature for 10 hours. Subsequently, all components which boiled at up to 70° C. and at 20 hPa were removed. The result was 26.1 g of a hard, amorphous mass with the following formula:

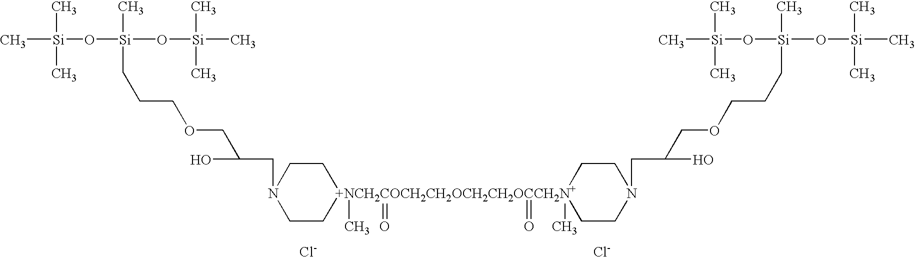

(The compound corresponds to the following definition of the claim:
R¹=methyl
n=0
K (left side)=

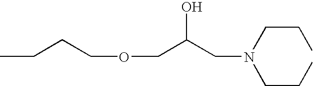

### Q1=

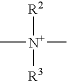

with R3=methyl and R2=bond to K
K (right side)=

### Q2<K′

with Q2=

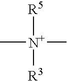

with R3=methyl

### and R5=—CH₂—CO—O—CH₂CH₂OCH₂CH₂O—CO—CH₂—

### K′=

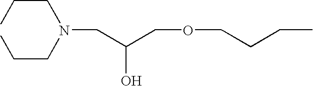

¹³C-NMR:

| Substructure | Shift (ppm) |
|---|---|
| —CH(OH)—CH₂—N—CH₂—CH₂—N⁺—CH₂—C(O)— | 66.0 |
| —CH(OH)—CH₂—N—CH₂—CH₂—N⁺—CH₂—C(O)— | 52.5 |
| —CH(OH)—CH₂—N—CH₂—CH₂—N⁺—CH₂—C(O)— | 45.6 |
| —CH(OH)—CH₂—N—CH₂—CH₂—N⁺—CH₂—C(O)— | 60.4 |
| —CH(OH)—CH₂—N—CH₂—CH₂—N⁺—CH₂—C(O)— | 61.3 |
| —CH(OH)—CH₂—N—CH₂—CH₂—N⁺—CH₂—C(O)— | 169.2/169.8 |
| CH₃—N⁺ | 52.9 |

### Example 3

110 g (0.03 mol) of an epoxy modified siloxane of the following statistical composition

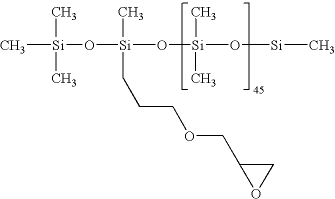

and 1.3 g (0.015 mol) piperazine were dissolved in 120 ml i-propanol and heated at reflux temperature for 5 hours. Following the conclusion of the reaction, all components which boiled at up to 100° C. and at 4 hPa were removed under vacuum. 109.7 g of a light yellow oil of the following structure:

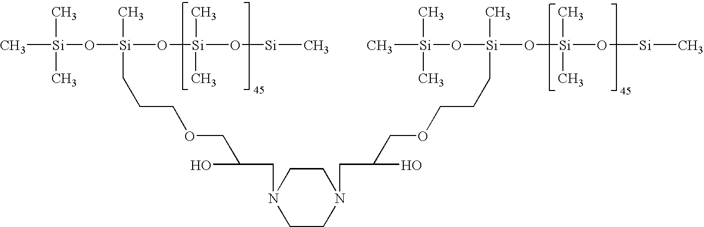

were obtained.

¹³C-NMR:

| Substructure | Shift (ppm) |
|---|---|
| —CH(OH)CH₂NCH₂ | 66.0 |
| —CH(OH)CH₂NCH₂ | 60.5 |
| —CH(OH)CH₂NCH₂ | 53.2 |

### Example 4

As proof of the softening properties as an internal softener during the washing process, strips of bleached cotton which had not undergone any further surface treatment were subject to a washing process in the presence of Ariel Futur®, Dash 2 in 1® containing bentonite, and the aminosiloxane described in Example 2. The following boundary conditions were maintained:

| | Strip 1 | Strip 2 | Strip 3 |
|---|---|---|---|
| Strip weight | 13.40 | 13.55 | 13.29 |
| (g) | | | |
| Water quantity | 669 | 679 | 665 |
| (ml) | | | |
| Detergent | 0.66 g Ariel | 0.68 g Ariel | 0.64 g Dash |
| | Futur ® | Futur ® | 2 in 1 ® |
| Siloxan | 0.2 g | — | — |
| Example 2 | | | |
| Average grade | 1.5 | 2.8 | 1.7 |

The water was heated to 60° C.; the detergents—and, in the case of cotton strip 1, also the aminosiloxane according to Example 2—were dissolved. Subsequently, the cotton strips were washed in these solutions for 30 minutes. After that, the strips were rinsed five times with 600 ml water each time, after which they were dried for 30 minutes at 120° C.

14 test persons evaluated the three cotton strips for softness to the touch. The grade of 1 was given to the softest strip and the grade of 3 was given to the strip which was perceived as hardest.

As a result of the evaluation, cotton strip 1 received an average grade of 1.5. Cotton strip 2 received an average grade of 2.8; cotton strip 3, which had been treated with bentonite, received an average grade of 1.7.

1. Monoquaternary or polyquaternary polysiloxane of the general formula (I),
S—K-Q¹-K—S (I)
wherein 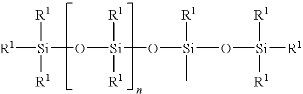
S is 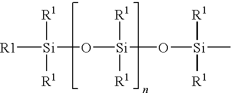
or
R¹ is C₁-C₂₂ alkyl, C₁-C₂₂ fluoroalkyl or aryl,
n is 0 to 1000,
Q¹ is a secondary amino structure 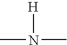
or a tertiary amino structure 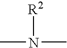
or a quaternary amino structure 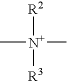
R² is a univalent or divalent, straight chain, cyclical or branched C₁-C₃₀ hydrocarbon radical, which is interrupted by —O—, —NH—, —C(O)—, —C(S)— and can be substituted with —OH or represents a single bond to the radical K,
R³ is a univalent, straight chain, cyclical or branched C₁-C₃₀ hydrocarbon radical, which is interrupted by —O—, —NH—, —C(O)—, —C(S)— and can be substituted with —OH or a structure -A-E-, with
A is —CH₂C(O)O—, —CH₂CH₂C(O)O— or —CH₂CH₂CH₂C(O)O— and
E is a polyalkylene oxide unit of the structure
—[CH₂CH₂O]_{q}—[CH₂CH(CH₃)O]ᵣ—R⁴
q is 1 to 200,
r is 1 to 200,
R⁴ is H, straight chain, cyclical or branched C₁-C₂₀ hydrocarbon radical, which is interrupted by —O— or —C(O)— and can be substituted with —OH and can be acetylene, olefin or aromatic,
whereby, when a plurality of R³ radicals are present in the molecule, these may be identical or different, and where
K is a divalent or trivalent, straight chain, cyclical or branched C₂-C₄₀ hydrocarbon radical, which is interrupted by —O—, —NH—, NR¹—, 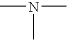
—C(O)—C(S) and can be substituted with —OH or contains a Q² unit, with
Q² is a secondary amino structure 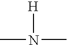
or a tertiary amino structure 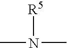
or a quaternary amino structure 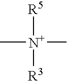
R⁵ is a univalent or divalent, straight chain, cyclical or branched C₁-C₂₀ hydrocarbon radical, which is interrupted by —O—, —NH—, —C(O)—, —C(S)— and can be substituted with —OH, whereby the free valence of the divalent radical R⁵ can bond to Q¹,
and when a large number of K radicals are present in the polysiloxane, these may be identical to or different from each other.

2. Monoquaternary or polyquaternary polysiloxane according to claim 1, wherein n is between 0 and 100.

3. Monoquaternary or polyquaternary polysiloxane according to claim 1, wherein q is between 1 and 50.

4. Monoquaternary or polyquaternary polysiloxane according to claim 1, wherein r is between 0 and 100.

5. Monoquaternary or polyquaternary polysiloxane according to claim 1, wherein R₂ and R₅ are —CH₃, —CH₂CH₃, —(CH₂)₂CH₃, —(CH₂)₃CH₃, —(CH₂)₅CH₃, —CH₂CH₂OH, 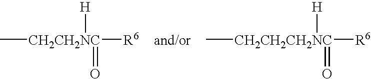
wherein R⁶ is a straight chain, cyclical or branched C₁-C₁₈ hydrocarbon radical, which is interrupted by —O—, —NH—, —C(O)—, —C(S)— and can be substituted with —OH.

6. Monoquaternary or polyquaternary polysiloxane according to claim 1, wherein R³ is —CH₃, —CH₂CH₃, —(CH₂)₂CH₃, —(CH₂)₃CH₃, —(CH₂)₅CH₃, —CH₂CH₂OH, 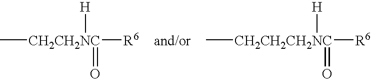
wherein R⁶ is a straight chain, cyclical or branched C₁-C₁₈ hydrocarbon radical, which is interrupted by —O—, —NH—, —C(O)—, —C(S)— and can be substituted with —OH.

7. Monoquaternary or polyquaternary polysiloxane according to any claim 1, wherein K is a divalent or trivalent, straight chain, cyclical or branched C₃-C₃₀
hydrocarbon radical, which is interrupted by —O—, —NH—, NR¹—, 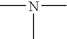
—C(O)—C(S) and can be substituted with —OH or contains a Q² unit.

8. Process for the manufacture of monoquaternary or polyquaternary polysiloxanes according to claim 1, wherein, for the manufacture of compounds containing quaternary ammonium groups of the general structure
S—K-Q¹-K—S
wherein
Q¹ is 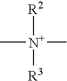
monofunctional, tertiary-amino-function-containing siloxane derivatives are alkylated with reactive, monofunctional siloxane derivatives, which are synthesized by hydrosilylation of, for example, halogenated alkenes, unsaturated halogen carbon acid esters, and epoxy-functional alkenes, with monofunctional SiH compounds of the general structures 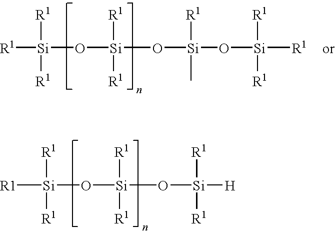
wherein the molar ratio of the tertiary amino function to the reactive alkylating group is advantageously 100:1 to 1:1.

9. Process for the manufacture of monoquaternary or polyquaternary polysiloxanes according to claim 8, wherein allyl chloride and allyl bromide are used as halogenated alkenes.

10. Process for the manufacture of monoquaternary or polyquaternary polysiloxanes according to claim 8, wherein unsaturated halogen carbon acid esters of the group consisting of chloroacetic acid allyl ester, chloroacetic acid propargyl ester, 3-chlorpropionic acid allyl ester, and 3-chlorpropionic acid propargyl ester are used as unsaturated halogen carbon acid esters.

11. Process for the manufacture of monoquaternary or polyquaternary polysiloxanes according to claim 8, wherein vinyl cyclohexene oxide and allyl glycidyl ether are used as epoxy-functional alkenes.

12. Process for the manufacture of monoquaternary or polyquaternary polysiloxanes according to claim 8, wherein, for the manufacture of tertiary-amino-function-bearing compounds of the general structure
S—K-Q¹-K—S
wherein 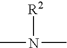
Q¹ is
secondary-amino-function-bearing unsaturated structures are directly bonded to the monofunctional Si—H siloxane through hydrosilylation and subsequently, along with monofunctional, reactive, alkylating siloxane intermediates, are converted into tertiary-amino-structure-bearing compounds, wherein the stoichiometry of the secondary amine to the reactive, alkylating siloxane is advantageously 1:1.

13. Process for the manufacture of monoquaternary or polyquaternary polysiloxanes according to claim 12, wherein n-methyl allylamine or CH₂═CHCH₂OCH₂CH(OH)CH₂NHCH₃ are used as secondary-amino-function-bearing unsaturated structures.

14. Process for the manufacture of monoquaternary or multiquaternary polysiloxanes according to claim 1, wherein, for the manufacture of tertiary-amino-function-bearing compounds of the general structure
S—K-Q¹-K—S
wherein
Q¹ is 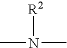
and K and S have the meanings according to claim 1, di-secondary amines along with monofunctional, reactive, alkylating siloxane intermediates, are converted into tertiary-aminostructure-bearing compounds, wherein the stoichiometry of the di-secondary amine to the reactive, alkylating siloxane is advantageously 1:2.

15. Process for the manufacture of monoquaternary or polyquaternary polysiloxanes according to claim 1, wherein, for the manufacture of equimolar quantities of tertiary-amino-function- and quaternary-ammonium-group-containing compounds of the general structure
S—K-Q′-K—S
secondary-tertiary diamines along with monofunctional, reactive, alkylating siloxane intermediates, are converted into di-tertiary-aminosiloxane-structure-bearing compounds, wherein the stoichiometry of the secondary-tertiary diamine to the reactive, alkylating siloxane is advantageously 1:1, and subsequently, the di-tertiary aminosiloxane structures, along with one mole of a monofunctional, reactive, alkylating siloxane compound, are converted to the tertiary-ammonium-group- and quaternary-ammonium-group containing siloxane derivatives.

16. Process for the manufacture of monoquaternary or polyquaternary polysiloxanes according to claim 1, wherein, for the manufacture of tertiary-amino-function- and quaternary-ammonium-group-containing compounds of the general structure
S—K-Q¹-K—S
di-secondary amines along with monofunctional, reactive, alkylating siloxane intermediates, are converted into tertiaryamino-structure-bearing compounds, whereby the stoichiometry of the di-secondary amine to the reactive, alkylating siloxane is advantageously 1:2, and subsequently alkylation with epoxides in the presence of acids, alkyl halogenides or halogen carbon acid esters, takes place, wherein the molar ratio of the tertiary amino groups to the alkylating agents is advantageously 100:1 to 11.

17. Process for the manufacture of monoquaternary or polyquaternary polysiloxanes according to claim 1, wherein, for the manufacture of quaternary-ammonium-group- and tertiary-amino-function-containing compounds of the general structure
S—K-Q¹-K—S
secondary amines or secondary-tertiary diamines along with monofunctional, reactive, alkylating siloxane intermediates are converted into tertiary- or di-tertiary-aminosiloxane-structure bearing compounds, whereby the stoichiometry of the secondary amine or the secondary-tertiary diamine to the reactive, alkylating siloxane is advantageously 1:1, and subsequently, the thus formed tertiary- or di-tertiary-aminosiloxane structures, along with a difunctional alkylating agent are converted into quaternary-ammonium-group-containing, or quaternary-ammonium-group- and simultaneously tertiary-amino-structure-containing siloxane derivatives.

18. Process for the manufacture of monoquaternary or polyquaternary polysiloxanes wherein the halogen carbon acid esters are used on low-molecular, oligomeric and polymeric alkylene oxides of the general structure
HO[CH₂CH₂O]_{q}[CH₂CH(CH₃)O]ᵣ—R⁴
wherein q, r and R⁴ have the meanings according to claim 1.

19. Process for the manufacture of monoquaternary or polyquaternary polysiloxanes according to claim 1, wherein halogen carbon acid esters from the group consisting of oligoethylene glycols with molar weights of 400, 600 and 800 g/mol are used as halogen carbon acid esters on low-molecular, oligomeric and polymeric alkylene oxides.

20. A cosmetic composition comprising monoquaternary or polyquaternary polysiloxanes, in which two siloxane units are bonded to each other by means of amino or ammonium units, according to claim 1.
